(19) United States
(12) Patent Application Publication
(10) Pub. No.: US 2026/0211708 A1
(43) Pub. Date: Jul. 23, 2026

(54) SYSTEMS AND METHODS FOR ONLINE SECURITIZATION OF ILLIQUID ASSETS

(71) Applicant: Rise Companies Corp., Washington, DC (US)

(72) Inventor: Benjamin MILLER, Washington, DC (US)

(21) Appl. No.: 19/034,289

(22) Filed: Jan. 22, 2025

Related U.S. Application Data
(63) Continuation of application No. 13/402,118, filed on Feb. 22, 2012, now abandoned.
(60) Provisional application No. 61/445,529, filed on Feb. 22, 2011.

(51) Int. Cl. G06F 9/451; H04L 67/306

(52) U.S. Cl. CPC G06F 9/451; H04L 67/306

(57) ABSTRACT

A system for online securitization of illiquid assets is disclosed. The system includes a physical storage media storing instructions for administering online securitization of illiquid assets and a processor. The processor is configured to execute the instructions for performing a method of receiving, over a network and from an owner of an illiquid asset, information relating to the illiquid asset. The processor is further configured for analyzing the information relating to the illiquid asset; securitizing the illiquid asset; generating an offer for purchasing an interest in the illiquid asset. The processor is further configured for transmitting the offer to an investor over the network; receiving payment from the investor, the payment being provided in consideration for the interest in the illiquid asset; and executing a transaction to transfer the interest in the illiquid asset to the investor.

### TECHNICAL FIELD

The present disclosure generally relates to computerized systems and methods for online securitization of illiquid assets. More particularly, and without limitation, embodiments of the present disclosure relate to computerized systems and methods for issuing shares in illiquid assets, such as real estate, to investors, by communicating electronic information over the Internet.

### BACKGROUND

Currently, private equity funds and investment sponsors must raise capital many months or longer before acquiring an asset (such as real estate or an operating company). The capital commitments are typically made before an asset is under contract, which makes the funder uncertain of the actual assets that will be purchased by the fund. As a result, such funds are often referred to as “blind pools.” One-off deals are sometimes performed, but they require an arduous undertaking of one-on-one pitch meetings, and extensive subscription/private documents. Rarely does the seller of an asset give the buyer enough time to raise the capital contemporaneously with the due diligence before closing. Moreover, the sellers are looking for the certainty of closing quickly. As a result, private equity funds and investors must effectively sit with excess inventory of committed capital to blind pool. These pre-commitments became a serious problem for many institutional investors during the 2008 economic crisis when they lacked the liquidity to fund their shares/commitments.

These problems are exacerbated for smaller deals lacking the ability to raise capital before putting their assets under contract. Sponsors typically raise money from an inefficient network of friends and family. These friends and family contacts may not be interested or have the funds to invest. The sponsors can hire broker-dealers/investment banks to raise the funds, but this too is costly, uncertain, and also involves arbitrary networks. Thus, sponsors or potential asset owners could benefit from new systems for online securitization of illiquid assets.

In contrast to sponsor networks, residents and customers of an asset rarely have opportunities to invest in the properties where they live, work, play, shop, or frequent. In fact, the group most likely to appreciate the value, contribute to the growth, and push to participate in the investment of a local property or asset are those who live in and around the asset. They are the natural shareholders who today cannot access specific local properties or businesses, but instead must choose REITs or other public vehicles of blended portfolios, and never get to buy what they know. Thus, patrons or residents of assets could benefit from new systems for online securitization of illiquid assets.

Institutional investors and local investors would prefer a medium whereby investments are provided to them and funded “just in time” giving them more control of asset selection and liquidity. Moreover, once such a medium is created it can act as a secondary market for those interests increasing liquidity where today there is almost none. Thus, investors could also benefit from new systems for online securitization of illiquid assets.

The current process to submit and receive regulatory approval for a public offering or exemption under Regulation A is extremely costly, slow, and otherwise burdensome. Moreover, the owner or tenant of the real estate interested in raising capital from the local or online community typically wishes to understand the potential demand for his offering, and thereby gauge the amount they could raise, the price for the security, and nature of the investor demand. For example, a property owner could choose to execute a lease with a local restaurant or a national fast-food chain. The property owner may wish to understand the investment demand for a property or leasehold with one tenant or the other, such as an Italian restaurant vs. a Japanese restaurant. Again, the restaurant owner would prefer to understand the potential capital available for one concept over another. Thus, prospective fundraisers would seek to understand the market demand before or while undertaking the process to securitize online an offering.

The disclosed embodiments of the present disclosure are directed to overcoming one or more of the problems set forth above. Among other things, the disclosed embodiments include computerized systems and methods for online securitization of illiquid assets.

### SUMMARY OF THE DISCLOSURE

According to one exemplary embodiment of the disclosure, a computer-implemented method is disclosed for online securitization of illiquid assets. The method includes receiving, over a network and from an owner or agent of an illiquid asset, information relating to the illiquid asset; and using a processor to analyze the information relating to the illiquid asset; securitize the illiquid asset; and generate an offer for purchasing an interest in the illiquid asset. The method also includes transmitting the offer to an investor over the network; receiving payment from the investor, the payment being provided in consideration for the interest in the illiquid asset; and executing a transaction to transfer the interest in the illiquid asset to the investor.

According to one exemplary embodiment of the disclosure, a system is disclosed for online securitization of illiquid assets. The system includes a physical storage media storing instructions for administering online securitization of illiquid assets; and a processor configured for: receiving, over a network and from an owner or agent of an illiquid asset, information relating to the illiquid asset; analyzing the information relating to the illiquid asset; and securitizing the illiquid asset. The processor is further configured for generating an offer for purchasing an interest in the illiquid asset; transmitting the offer to an investor over the network; receiving payment from the investor, the payment being provided in consideration for the interest in the illiquid asset; and executing a transaction to transfer the interest in the illiquid asset to the investor.

According to one exemplary embodiment of the disclosure, a non-transitory, computer-readable medium is disclosed, the medium storing instructions that, when executed by a computer, cause the computer to perform a method for online securitization of illiquid assets. The method includes receiving, over a network and from an owner or agent of an illiquid asset, information relating to the illiquid asset; and using a processor to: analyze the information relating to the illiquid asset; securitize the illiquid asset; and generate an offer for purchasing an interest in the illiquid asset. The method also includes transmitting the offer to an investor over the network; receiving payment from the investor, the payment being provided in consideration for the interest in the illiquid asset; and executing a transaction to transfer the interest in the illiquid asset to the investor.

Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

The accompanying drawings, which are incorporated in and constitute a part of this disclosure, illustrate several embodiments and aspects of the present disclosure, and together with the description, serve to explain certain principles of the invention. In the drawings:

FIG. 1 is a block diagram of an exemplary environment for systems and methods for online securitization of illiquid assets, consistent with certain embodiments of the present disclosure;

FIG. 2 is a flow diagram of an exemplary method for online securitization of illiquid assets, consistent with certain embodiments of the present disclosure;

FIG. 3 is another flow diagram of an exemplary method for online securitization of illiquid assets, consistent with certain embodiments of the present disclosure; and

FIG. 4 is another flow diagram of an exemplary method for online securitization of illiquid assets, consistent with certain embodiments of the present disclosure.

Like reference symbols in the various drawings indicate like elements. For brevity, several elements in the figures described below are represented as monolithic entities. However, as would be understood by one skilled in the art, these elements each may include numerous interconnected computers and components designed to perform a set of specified operations and/or dedicated to a particular geographic region.

Additional objects and advantages will be set forth in part in the description which follows, and in part will be apparent from the description, or may be learned by practice of the embodiments of the invention. For example, the objects and advantages may be realized and attained by means of the elements and combinations particularly pointed out in the appended claims.

It is to be understood that both the foregoing general description and the following detailed description are exemplary and explanatory only and are not restrictive of the invention, as claimed.

### DETAILED DESCRIPTION

Accordingly, electronic systems and methods are disclosed whereby investors are matched with real estate or small business sponsors, so investors may obtain shares in assets owned by or supporting those sponsors. The presently-disclosed systems and methods will sometimes be described with respect to “local” investors and “local” asset owners. For example, patrons of a coffee shop who live nearby the coffee shop may desire to invest in shares of the coffee shop business or the property in which it operates. However, it will be appreciated that the disclosed embodiments are not limited to local investors and asset owners. Indeed, investors might desire to acquire liquid shares of assets located anywhere in the world, and owners may be interested in receiving investments from investors located anywhere in the world.

Moreover, the presently-disclosed systems and methods will sometimes be described with respect to real estate assets. However, it will be appreciated that the presently-disclosed systems and methods are applicable to literally any type of traditionally illiquid asset, such as a business, fund, land, leasehold interests, debt instruments, improvements, or any other asset for which investors typically cannot easily buy and sell shares. In fact, assets subject to these systems need not be “illiquid” per se, but just less liquid than desired by investors who could use the presently disclosed systems to improve their access to investments in those assets.

Accordingly, the presently disclosed systems and methods may provide electronic networks by which capital can be raised from the local community, to which the asset is known, local, and staked in. A REIT, 1-A, S-1, or S-11 structure may be used to match each investment with a share of specific assets back-to-back rather than through a blended portfolio, thereby tying the performance of an investment to a specific property or a small group of properties. The presently disclosed systems and methods provide a mechanism by which the community can make a direct stake in local assets and interact with the owner and each other to promote the asset's success. The presently disclosed systems and methods provide a mechanism to fund assets directly from the local community “Just In Time,” as compared to a pre-committed blind pool.

According to exemplary embodiments, the presently disclosed systems and methods provide an online platform to raise capital for specific deals just in time or simultaneous with closing, thereby fulfilling a need missing from the economy. Investors and asset owners may interact with the system over a network, such as the Internet, using any suitable computer, device, or mobile device. Investors and asset owners may create profiles, or link their profiles with accounts on existing social networks. In an exemplary embodiment, a new user may register online to become eligible to invest in securities offered through a website. The initial signup (registration) may involve information like first/last name, username, password, email address, phone number, social security number, date of birth, address, and an agreement to the terms and conditions. Once the user has filled out the details and agreed to the terms and conditions, the server-client form validation may be performed to validate the information entered. After the validation, a user may be sent an email with a link containing a key to verify their email address. Upon clicking on the link, the user's email may be verified and the user account is activated. Once the user account has been activated, the user may login with the provided username and password. In an exemplary embodiment, a timestamp is recorded to determine an investor's eligibility to invest in a particular security upon the account activation. The user's activation timestamp may be prior to the security's opening date. In another exemplary embodiment, new users may be allowed to purchase recent offerings. However, users will only be able to purchase securities once their account is funded.

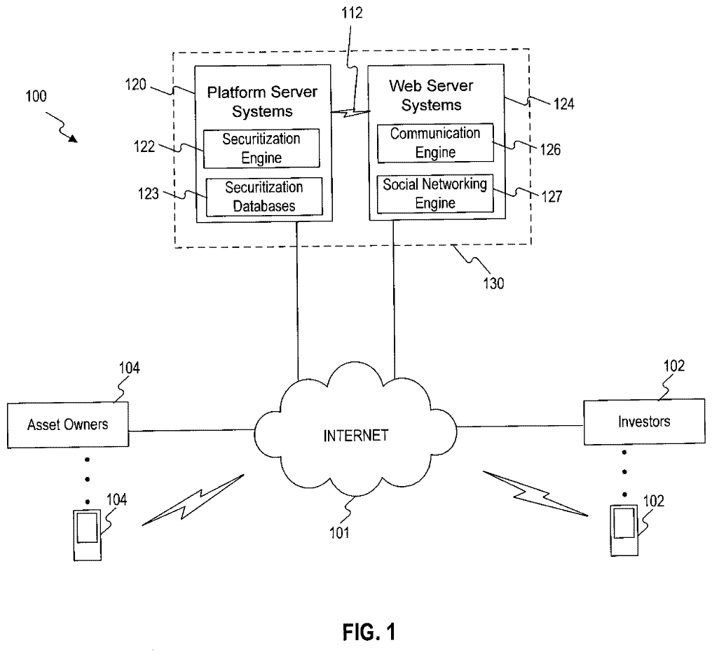

FIG. 1 depicts an exemplary environment 100 for online securitization of illiquid assets. Environment 100 may include an online securitization platform 130 provided in communication with the Internet 101. Online securitization platform 130 may include, for example, platform server systems 120 and web server systems 124. Both platform server systems 120 and web server systems 124 may be individually connected to the Internet 101. Platform server systems 120 and web server systems 124 may communicate with each other through the Internet 101 or through a direct communication link 112. In one embodiment, platform server systems 120 and web server systems 124 may be operated by a common owner. That is, online securitization platform 130 may be fully owned and operated by a single corporate entity. Alternatively, one or both of platform server systems 120 and web server systems 124, or components thereof, may be owned and operated by separate corporate entities. For example, an online securitization platform company may operate platform server systems 120, while outsourcing the functions of web server systems 124 to an Internet vendor.

Environment 100 may also include investors 102, which interact with other entities over the Internet 101 through computers or mobile devices connected to the Internet 101. Environment 100 may also include asset owners 104, which interact with other entities over the Internet 101 through computers or mobile devices connected to the Internet 101. In general, investors 102 and asset owners 104 may communicate with online securitization platform 130 over the Internet 101 to perform the exemplary online securitization techniques disclosed herein. For example, asset owners 104 may send information about their available asset investments to platform server systems 120, e.g., by interacting with websites executed by web server systems 124. Investors 102 may send information about themselves and their financial information to platform server systems 120, e.g., by interacting with websites executed by web server systems 124. In turn, the online securitization platform 130 may send information about available asset investments to investors 102 upon request, and may send information about investors 102 to asset owners 104 upon request, all through the Internet 101.

Investors 102 and/or asset owners 104 may implement any type or combination of computing systems, such as personal computers, mobile devices, clustered computing machines, and/or servers. In one embodiment, each computing system may be an assembly of hardware, including a memory, a central processing unit (“CPU”), and/or a user interface. The memory may include any type of RAM or ROM embodied in a physical storage medium, such as magnetic storage including hard disk or magnetic tape; semiconductor storage such as solid state disk (SSD) or flash memory; optical disc storage; or magneto-optical disc storage. The CPU may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software. The user interface may include any type or combination of input/output devices, such as a display monitor, touchscreen, keyboard, and/or mouse. Mobile devices used by investors 102 or asset owners 104 may be configured to access wireless digital data, telephone, and/or Internet access through any other wireless communication medium, such as, for example, local or wide area Wi-Fi or Bluetooth connectivity. Mobile devices may include any type or combination of mobile phones, personal digital assistants (“PDAs”), so-called “smartphones,” tablet PC computers, or any other mobile device configured to receive communications, and display data to a user.

Platform server systems 120 and/or web server systems 124 of online securitization platform 130 may implement any type or combination of computing systems, such as personal computers, clustered computing machines, and/or servers. In one embodiment, each computing system may be an assembly of hardware, including a memory, a central processing unit (“CPU”), and/or a user interface. The memory may include any type of RAM or ROM embodied in a physical storage medium, such as magnetic storage including hard disk or magnetic tape; semiconductor storage such as solid state disk (SSD) or flash memory; optical disc storage; or magneto-optical disc storage. The CPU may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software.

In one embodiment, one or more processors of the platform server systems 120 may execute a securitization engine 122 according to instructions stored in one or more memory devices of the platform server systems 120. In addition, the platform server systems 120 may store data received from one or more of the investors 102 or asset owners 104 in securitization databases 123. For example, securitization databases 123 may store user profile information relating to investors 102, such as demographic or financial data. Securitization databases 123 may also store information relating to asset owners 104, such as profile information, asset information, financial information, risk information, prospectus information, or the like.

In addition, one or more processors of the web server systems 124 may execute a communication engine 126 and/or a social networking engine 127 according to instructions stored in one or more memory devices of the web server systems 124. For example, web server systems 124 may execute a communication engine 126 for transmitting and receiving information to and from investors 102 and/or asset owners 104. Communication engine 126 may provide mechanisms for generating automated messages, and scheduling the timing and sending of those messages to investors 102 and/or asset owners 104 over the Internet 101. Communication engine 126 may also provide mechanisms for receiving messages from investors 102 and/or asset owners 104, and forwarding those messages, or data from those messages, to platform server systems 120, for execution by securitization engine 122 and/or storage in securitization databases 123. One or more processors of the web server systems 124 may also execute social networking engine 127, e.g., for enabling investors 102 and/or asset owners 104 to create and manage social networking user profiles, or to link to or otherwise interface with user profiles of other social networks.

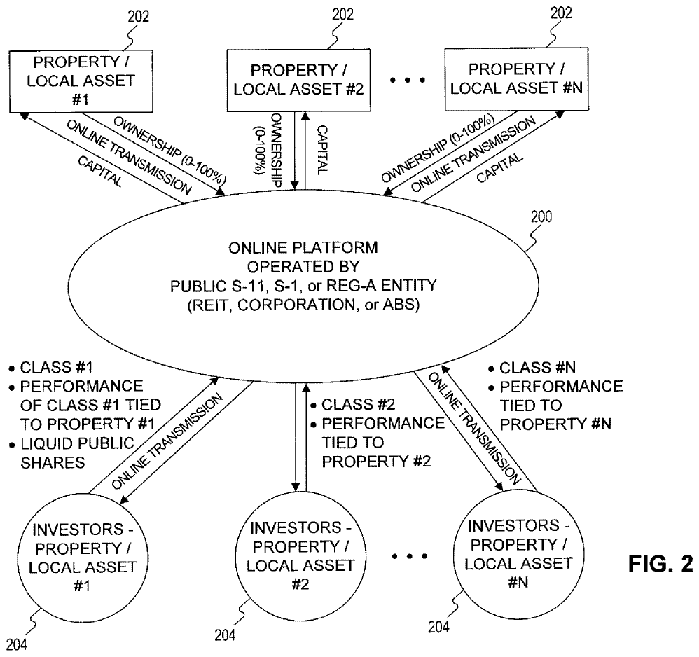

FIG. 2 depicts a flow diagram of an exemplary method for online securitization of illiquid assets. Specifically, an online platform 200 operated by a public S-11, S-1, or Reg-A registered entity may implement platform server systems 120 and/or web server systems 124 of online securitization platform 130 to transfer ownership interests in one or more properties, tenants, or local assets 202 to investors 204 over an electronic network, such as the Internet. Specifically, asset owners 104 may transfer ownership interests in their property, leasehold, small business, or other assets 202 through the online platform 200 to one or more of investors 204. In one embodiment, investors in asset #1 may then own equity shares in asset #1, where performance of that investment is directly related to performance of asset #1, and those shares are made liquid by virtue of their availability through online platform 200. Investors in asset #2 may own equity shares in asset #2, where performance of that investment is directly related to performance of asset #2, and those shares are made liquid by virtue of their availability through online platform 200, and so on. Online platform 200 may implement the online securitization platform 130 of FIG. 1 to handle origination and underwriting issues, prepare standardized public disclosure materials, enable centralized asset management, and provide mechanisms for data management, as discussed in more detail below.

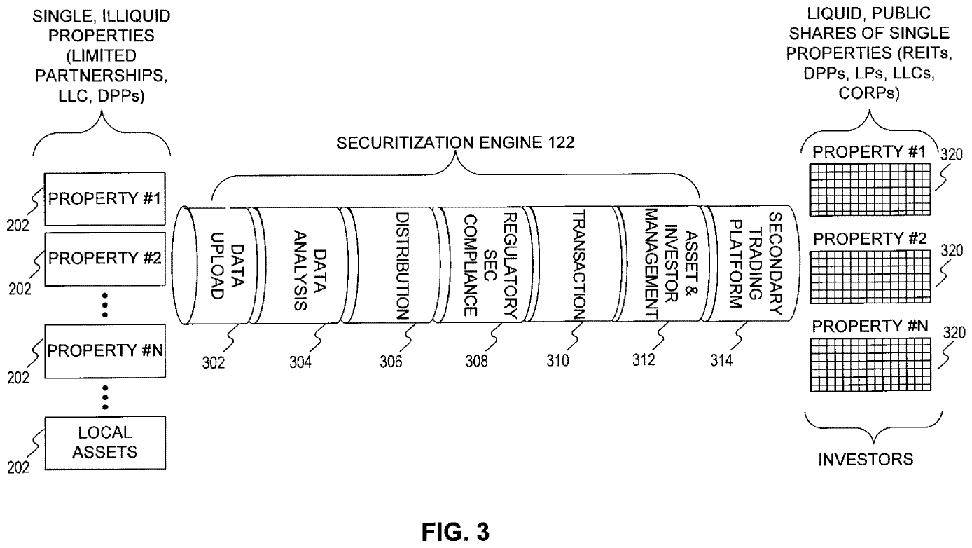

FIG. 3 depicts a process flow for securitizing ownership interests in properties or local assets, using an exemplary embodiment of securitization engine 122. Specifically, the platform server systems 120 may receive asset information from asset owners 104 and investor information from investors 102, and execute securitization engine 122 to convert one or more single illiquid assets, such as properties 202 (Property #1, Property #2. . . Property #N) into liquid public shares 320 of those single assets (Shares 320 of Property #1, Shares 320 of Property #2, Shares 320 of Property #N).

As discussed above, although the platform, systems, and methods are described with respect to local assets, illiquid assets, and/or real property, it will be appreciated that the disclosed embodiments are merely exemplary in nature, and are not to be construed as limiting on the potential applications of these features. For example, the presently disclosed systems and methods may be used for automated securitization of nearly any assets. Moreover, the presently disclosed systems and methods are contemplated as being integrated into virtually any existing online commerce, database, social networking, or communications system.

In one embodiment, execution of securitization engine 122 may first involve data upload (step 302), such as through web server systems 124. For example, asset owners 104 may interact with web server systems 124 to fill out a template of key datapoints regarding their assets 202, such as price, location, photos, loan documentation, leases, or any other useful information regarding assets 202. Web server systems 124 may receive this information and convey this information to platform server systems 120 for storage in securitization databases 123.

Securitization engine 122 may then include data analysis (step 304). For example, the online securitization platform 130 may develop and implement a tight filter through which properties must qualify before they are available for online scrutiny, including performing credit reports, background checks, maximum loan-to-value ratios (LTV), and maximum co-investment. Prior to funding, the local title company may be given a thorough closing checklist to ensure clear title, co-funding, and title recordation, among other things. Thus, securitization engine 122 may, for example, test data and information received from asset owners 104 against some preset criteria, such as LTV, NAV, location, etc., perform underwriting, e.g., using a due diligence checklist, and executing a rating system for risk/return, SEC disclosures, etc.

Securitization engine 122 may then include distribution of investment information to potential investors (step 306), such as through web server systems 124. For example, securitization engine 122 may create a template of an asset website summarizing an available asset, and/or a dataroom from which information about the asset may be downloaded. Securitization engine 122 may also interact with communication engine 126 and/or social networking engine 127 of web server systems 124 to distribute the website, emails, social networking pages, or any other electronic descriptions of an available investment to one or more investors 102. Social networking engine 127 may enable investors to comment on, “like,” and/or share information about available investments.

Securitization engine 122 may then include performing regulatory SEC compliance (step 308). For example, securitization engine 122 may automatically generate required SEC filing documents, or at least partially filled templates of SEC filing documents. For example, securitization engine 122 may use information received from asset owners 104 to start preparing SEC filing documents that are later completed by qualified investment managers or securities attorneys. Or in another example, the owner may present the registered filing and/or sales material to an online investor, but the online investor may find such legal documents difficult to understand without a systematic process to present, review, or search such materials while the offeror still maintains compliance with the myriad securities regulations. In one embodiment, asset owners 104 may transmit asset information to securitization engine 122 in a structured manner, such as using forms, tags, or other metadata, so that securitization engine 122 knows what data corresponds to what requested information, thereby enabling securitization engine 122 to auto-generate SEC filing documents. In one embodiment, the information and/or filings submitted by the owner are processed, presented, and transacted such that the offering maintains compliance with the regulations and prohibitions on the offer and sale of securities to the public. In one embodiment, the securitization engine may display an amount of investment made in the real property to-date relative to an amount of investment available for purchase. By registering an S-11 or as a FINRA registered broker-deal for Regulation A offerings or adhering to Regulation D, the online securitization platform 130 may sell real estate related securities to qualified members of the site.

Securitization engine 122 may then include executing transactions with interested investors (step 310). For example, securitization engine 122 may receive, such as through web server systems 124, an expression of an investor's interest in purchasing a share of an asset 202. Based on the received expression of interest, the securitization engine may further estimate an amount of money that may be raised from the investors or potential investors and a price of purchasing the partial share in or unit of the entity that holds an interest in the real property. Securitization engine 122 may enable investors to electronically sign transaction agreements, such as a private placement memorandum (“PPM”), subscription documents, operating agreements, terms and conditions, etc. Securitization engine may also enable investors to provide online payment, such as through ACH, credit card, wire, check, or third-party payment services. In one embodiment, securitization engine 122 may enable online signatures and payment in combination with web server systems 124.

Securitization engine 122 may then include enabling asset and investor management (step 312). For example, securitization engine 122 may offer online investment management tools to investors 102, such as for distributions, taxes, reporting, etc. Securitization engine 122 may also offer asset management tools to asset owners 104, such as for property oversight, property servicing, etc. Securitization engine 122 may also enable affinity management services, where investors who are also patrons of the assets may earn discounts, recognition at point-of-service, etc.

In one embodiment, a secondary trading platform may also be created (step 314), whereby investors may re-sell their shares in the assets. For example, the trading platform may set pricing for redemption, marketing maker, back-to-back, etc. the trading platform may also offer marketplace display, bidding/auction, and/or clearing.

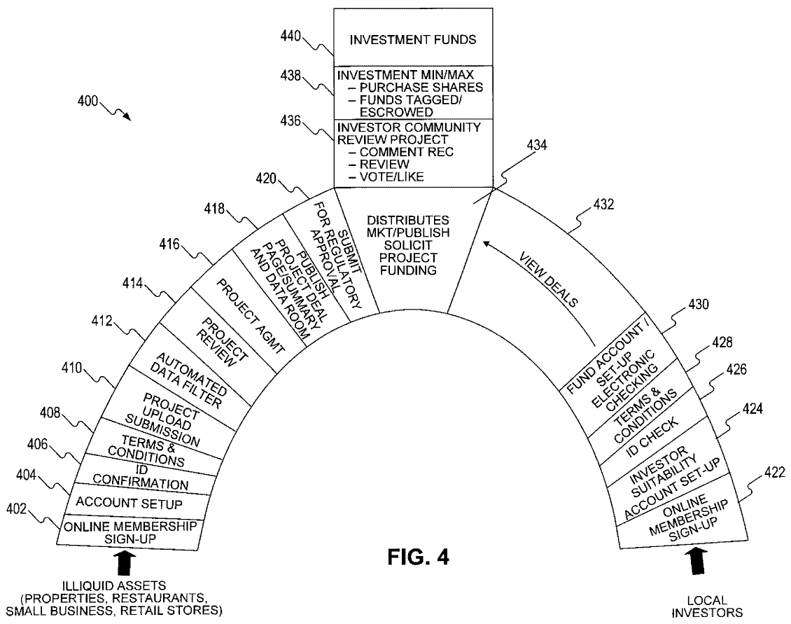

FIG. 4 depicts another flow diagram of another exemplary process 400 for online securitization of illiquid assets, using online securitization platform 130. Process 400 may include owners of illiquid assets interacting with web server systems 124 for online membership sign-up (step 402). Asset owners may setup an account (step 404), receive confirmation of a unique user ID (step 406), and agree to certain terms and conditions (step 408). Asset owners may then upload a “project” for submission (step 410). For example, asset owners may upload information about an asset, such as a property, including property descriptions, economic/financial information, income statements, balance sheets, photos of a property, or the like. In one embodiment, the asset owner may use the uploaded information to test the investment demand before undergoing the securitization process.

As shown in FIG. 4, the online platform 200 may perform automated data filtering (step 412) and project review (step 414). For example, the online platform 200 may automatically screen key information provided by asset owners for factors like income, NOI, debt-to-equity, location, setting, etc. Online platform 200 may also perform due diligence, such as of project data. Asset owners and/or the online platform 200 may also execute a project agreement (step 416) defining terms of the securitization of the asset. For example, for a project valued at $1,000,000, the asset owner and online platform 200 may agree to issue 200 shares valued at $5,000 each. Asset owners and/or the online platform 200 may then publish information about the project (step 418), such as on a website using web server systems 124, or within an online data room. Asset owners and/or the online platform 200 may also submit the published project for regulatory approval or to test investment demand (step 420).

Asynchronously and independent from an asset owner's interaction with the online platform 200 via online platform system 130, one or more investors may interact with online platform system 130, such as by signing-up for a membership with web server systems 124 (step 422). An investor may interact with the online platform 200 to determine whether the investor is suitable for engagement with the platform and set-up an account (step 424). The investor may receive a unique ID (step 426), electronically agree to terms and conditions (step 428), and fund his or her account (step 430), such as by using electronic checking, ACH, credit card, or third-party payment services. An investor may then view available “deals” or liquid shares of otherwise illiquid projects or assets that the investor may invest in (step 432).

Asynchronously and independent from an investor's interaction with the online platform 200 via online platform system 130, the online platform 200 and/or asset owners 104 may attempt to market one or more projects, such as by distributing or publishing information about the one or more projects (step 434). For example, as described above, the online platform 200 may distribute electronic messages using communication engine 126 of web server systems 124, or social networking engine 127 of web server systems 124. Alternatively, the online platform 200 may use web server systems 124 to publish websites that investors can view to receive information about available assets to invest in.

The investor community may then access information published or distributed by the online platform 200 or asset owners 104 (step 436), to provide comments, due diligence information, or vote or “like” a given available asset. Potential investors may purchase shares, fund the minimum or up to the maximum offered, etc. (step 438). Finally, online platform 200 may execute a transaction through online platform system 130, by which investors may become owners of liquid shares in otherwise illiquid assets made available by asset owners (step 440). In an exemplary embodiment, when an investor purchases shares, a timestamp of the purchase order has been recorded. Orders of investors are processed in a first-in-out manner that is determined by the timestamp of the record in the database. Once the asset is fully funded and all transactions have been successfully completed, an email notification about the market cap and closing date is sent out to investors.

Accordingly, a computer-implemented method is disclosed for online securitization of illiquid assets. The method includes receiving, over a network and from an owner of an illiquid asset, information relating to the illiquid asset such as property summary, balance sheet, development budget, return analysis (not including for their fractional share), sources and uses, and loan summary. The method further includes using a processor to analyze the information relating to the illiquid asset; securitize the illiquid asset; and generate an offer for purchasing an interest in the illiquid asset. The method further includes transmitting the offer to an investor over the network; receiving payment from the investor, the payment being provided in consideration for the interest in the illiquid asset; and executing a transaction to transfer the interest in the illiquid asset to the investor.

In one embodiment, analyzing includes performing underwriting analysis, or rating, checking, or providing the illiquid asset for risk factors or for certain financial information. In one embodiment, information includes one or more of a property address, owner name, total debt, total equity, zoning information, tenant and lease information, biographies, market information, such as comparable rents, economic forecast returns, share price, offering amount, and cash flow information. In one embodiment, the method further comprises submitting S-11 public disclosure documents, Reg-A documents, or internal compliance documents to a regulatory agency, over the network, prior to or with execution of the transaction. In one embodiment, the method further comprises processing S-11 or S-1 public disclosure documents, Reg-A documents, or regulatory compliance documents, including in each instance associated sales material, over the network, prior to or with execution of the transaction such that the offering and sale of securities to the public maintains compliance with regulatory requirements.

In one embodiment, the illiquid asset is real property, a leasehold interest, or a debt instrument. In one embodiment, the method further comprises receiving electronic signatures from the investor and the owner before execution of the transaction. In one embodiment, the method further comprises enabling owners and investors to create online profiles that can be viewed by other owners and investors, the online profiles including one or more of: illiquid asset ownership, securitized interests in illiquid assets, demographic information, and personal interest information. In one embodiment, the owner of an asset gauges potential demand for investment from the local community over a network before undergoing online securitization or making a public offer for a security.

In addition, a system is disclosed for online securitization of illiquid assets. The system includes a physical storage media storing instructions for administering online securitization of illiquid assets; and a processor. The processor is configured for: receiving, over a network and from an owner of an illiquid asset, information relating to the illiquid asset; analyzing the information relating to the illiquid asset; securitizing the illiquid asset; generating an offer for purchasing an interest in the illiquid asset; transmitting the offer to an investor over the network; receiving payment from the investor, the payment being provided in consideration for the interest in the illiquid asset; and executing a transaction to transfer the interest in the illiquid asset to the investor.

Aside from access to capital, the presently disclosed systems and methods offer an electronic platform for businesses to deepen their relationship with their investors and customers. Businesses can offer promotions for products or solicit advice about tenancy, locations, and expansion plans. The presently disclosed systems and methods establish a central communication platform that allows owners to motivate their investors to take actions to increase the value of the brand and asset or purchase more shares thereby investing more in the company.

The presently disclosed systems and methods provide an online peer-to-peer real estate investment platform that allows: (i) individuals to invest directly in specific properties of their choosing; (ii) developers to raise capital directly for one-off deals from the public; (iii) the community to have input into and a direct stake in the economic success of local real estate; and (iv) ownership interests in properties to become a liquid asset.

In addition, the presently disclosed systems and methods provide an online social media investment platform that simplifies and transforms the process of, and the market for, real estate related fundraising. The investment and development process for real estate was previously unchanged despite the advancement of information technology. However, real estate—because of powerful presence in every day life—is well suited to advances in online consumer behavior and related technology.

Real estate is local, tactile, accessible, familiar, and understandable, not to mention more than 8% of the entire US economy. The built environment within which we all live, work, shop, and play totals more than $6 trillion within the United States commercial real estate sector alone. By creating an open investment platform that integrates in the online community, real estate professionals, property owners, and active investors, the presently disclosed systems and methods harness the vast social media power of real estate to drive direct investment and community development. The presently disclosed systems and methods provide a paperless fundraising and offering platform that reduces complexity and transactions costs. Instead of approaching each deal as a one off transaction, the presently disclosed systems and methods systematize portions of the fundraising process and keeps organized, searchable records of all documents.

In addition, the technological and regulatory context has matured to make it opportune for online private offering of real estate. Only in March 2009 did the SEC institute electronic filing of Form D, a necessary filing for private offerings. Developments in social media have proven that individuals can collaborate online to lend directly in their peers, produce sophisticated, joint analysis (e.g., Wikipedia), or simply transact together as a community (e.g., eBay, Groupon). While in the physical world, the demand for real, simple, local, cash flowing investments is greater than perhaps ever before. Yet, for small-scale developers, tenants, and property owners the supply of institutional and bank funding is drastically lower than in many years; moreover, exacerbated by the billions of forced de-leveraging and recapitalizations required over the coming half decade.

The presently disclosed systems and methods connect investors directly to sponsors, dis-intermediating the traditional Wall Street capital conduits that recently failed so dramatically. Unlike peer-to-peer consumer lending, the presently disclosed systems and methods tap into the much more dynamic and magnetic power of real estate acquisition, tenancy, investment, finance, and development. Real estate is a much more intuitive and familiar investment than online consumer lending. However, until now retail investors had no access to invest in individual properties or tenants unless they chose to become active real estate sponsors or knew one to invest with, and were qualified accredited investors, meaning having more than $1,000,000 in liquid assets. Now, investors, property owners, tenants, and the online community can work together to build their own place-based portfolios.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A computer-implemented method for positioning elements of a user interface in real-time using a platform server system, the method comprising:
receiving, by one or more processors, a plurality of data associated with a unique identifier of a unit;
determining, by the one or more processors, that the plurality of data satisfies a set of criteria associated with a user;
generating, by the one or more processors, a first user element based on determining that the plurality of data satisfies the set of criteria, the first user element comprising the plurality of data;
accessing, by the one or more processors and in a database associated with the platform server system, a user profile associated with the user;
generating, by the one or more processors, the user interface comprising the first user element;
displaying, by the one or more processors, the user interface on a display of a user device associated with the user;
capturing, by the one or more processors, one or more real-time user interactions with the first user element;
linking, by the one or more processors, the unique identifier to the user profile in the database based on the one or more real-time user interactions;
updating, by the one or more processors, the user interface with a second user element including the unique identifier based on the linking;
receiving, via the second user element in the user interface, a user selection of the unique identifier;
determining, by the one or more processors, that two or more transfer elements are associated with the unique identifier based on receiving the user selection, wherein the two or more transfer elements are each associated with a unique time indicator; and
automatically positioning, by the one or more processors and in the user interface, a transfer element associated with the user relative to one or more other transfer elements of the two or more transfer elements based on each unique time indicator and according to a share size of the unit associated with each transfer element.

2. The computer-implemented method of claim 1, further comprising:
displaying, by the one or more processors, a notification in the user interface comprising a completion date and the share size.

3. The computer-implemented method of claim 1, further comprising:
displaying, by the one or more processors, the share size associated with each transfer element according to the positioning.

4. The computer-implemented method of claim 1, further comprising:
in response to receiving the user selection, generating, by the one or more processors and in the database, a registered user profile associated with the user;
validating, by the one or more processors, the registered user profile; and
generating, by the one or more processors, a user profile activation time indicator for the registered user profile based on the validating.

5. The computer-implemented method of claim 4, further comprising:
comparing, by the one or more processors, the user profile activation time indicator to a time indicator associated with the second user element to verify the user.

6. The computer-implemented method of claim 1, wherein the user profile comprises user data including interest data.

7. The computer-implemented method of claim 1, wherein the one or more real-time user interactions with the first user element indicates an interest of the user.

8. A system comprising:
a memory storing instructions for positioning elements of a user interface in real-time; and
a processor configured to execute the instructions to perform operations comprising:
receiving, by one or more processors, a plurality of data associated with a unique identifier of a unit;
determining, by the one or more processors, that the plurality of data satisfies a set of criteria associated with a user;
generating, by the one or more processors, a first user element based on determining that the plurality of data satisfies the set of criteria, the first user element comprising the plurality of data;
accessing, by the one or more processors and in a database associated with the system, a user profile associated with the user;
generating, by the one or more processors, the user interface comprising the first user element;
displaying, by the one or more processors, the user interface on a display of a user device associated with the user;
capturing, by the one or more processors, one or more real-time user interactions with the first user element;
linking, by the one or more processors, the unique identifier to the user profile in the database based on the one or more real-time user interactions;
updating, by the one or more processors, the user interface with a second user element including the unique identifier based on the linking;
receiving, via the second user element in the user interface, a user selection of the unique identifier;
determining, by the one or more processors, that two or more transfer elements are associated with the unique identifier based on receiving the user selection, wherein the two or more transfer elements are each associated with a unique time indicator; and
automatically positioning, by the one or more processors and in the user interface, a transfer element associated with the user relative to one or more other transfer elements of the two or more transfer elements based on each unique time indicator and according to a share size of the unit associated with each transfer element.

9. The system of claim 8, the operations further comprising:
displaying, by the one or more processors, a notification in the user interface comprising a completion date and the share size.

10. The system of claim 8, the operations further comprising:
displaying, by the one or more processors, the share size associated with each transfer element according to the positioning.

11. The system of claim 8, the operations further comprising:
in response to receiving the user selection, generating, by the one or more processors and in the database, a registered user profile associated with the user;
validating, by the one or more processors, the registered user profile; and
generating, by the one or more processors, a user profile activation time indicator for the registered user profile based on the validating.

12. The system of claim 11, the operations further comprising:
comparing, by the one or more processors, the user profile activation time indicator to a time indicator associated with the second user element to verify the user.

13. The system of claim 8, wherein the user profile comprises user data including interest data.

14. The system of claim 8, wherein the one or more real-time user interactions with the first user element indicates an interest of the user.

15. A non-transitory computer-readable medium storing instructions that, when executed by a platform server system, cause the platform server system to perform a method for positioning elements of a user interface in real-time, the method comprising:
receiving, by one or more processors, a plurality of data associated with a unique identifier of a unit;
determining, by the one or more processors, that the plurality of data satisfies a set of criteria associated with a user;
generating, by the one or more processors, a first user element based on determining that the plurality of data satisfies the set of criteria, the first user element comprising the plurality of data;
accessing, by the one or more processors and in a database associated with the platform server system, a user profile associated with the user;
generating, by the one or more processors, the user interface comprising the first user element;
displaying, by the one or more processors, the user interface on a display of a user device associated with the user;
capturing, by the one or more processors, one or more real-time user interactions with the first user element;
linking, by the one or more processors, the unique identifier to the user profile in the database based on the one or more real-time user interactions;
updating, by the one or more processors, the user interface with a second user element including the unique identifier based on the linking;
receiving, via the second user element in the user interface, a user selection of the unique identifier;
determining, by the one or more processors, that two or more transfer elements are associated with the unique identifier based on receiving the user selection, wherein the two or more transfer elements are each associated with a unique time indicator; and
automatically positioning, by the one or more processors and in the user interface, a transfer element associated with the user relative to one or more other transfer elements of the two or more transfer elements based on each unique time indicator and according to a share size of the unit associated with each transfer element.

16. The non-transitory computer-readable medium of claim 15, the method further comprising:
displaying, by the one or more processors, a notification in the user interface comprising a completion date and the share size.

17. The non-transitory computer-readable medium of claim 15, the method further comprising:
displaying, by the one or more processors, the share size associated with each transfer element according to the positioning.

18. The non-transitory computer-readable medium of claim 15, the method further comprising:
in response to receiving the user selection, generating, by the one or more processors and in the database, a registered user profile associated with the user;
validating, by the one or more processors, the registered user profile; and
generating, by the one or more processors, a user profile activation time indicator for the registered user profile based on the validating.

19. The non-transitory computer-readable medium of claim 18, the method further comprising:
comparing, by the one or more processors, the user profile activation time indicator to a time indicator associated with the second user element to verify the user.

20. The non-transitory computer-readable medium of claim 15, wherein the user profile comprises user data including interest data.
